(19) United States
(12) Patent Application Publication
(10) Pub. No.: US 2013/0259273 A1
(43) Pub. Date: Oct. 3, 2013

(54) Speaker Guard for Audio Devices

(71) Applicant: David Hyung Chin, Glendale, CA (US)

(72) Inventor: David Hyung Chin, Glendale, CA (US)

(21) Appl. No.: 13/431,861

(22) Filed: Mar. 27, 2012

(51) Int. Cl. H04R 25/00

(52) U.S. Cl. 381/189

(57) ABSTRACT

A method and apparatus providing for the protection of the sound emitted by an audio device from physical interference during use of the audio device. Such an audio device in which said audio device may further function as at least one of the following: mobile phone, telephone, smart phone, or multimedia player. Such a method and apparatus comprising a housing with an extended portion about the speakers of the audio device whereby said extended portion protects the speakers from being covered or obstructed by unwanted material or objects.

### FIELD OF THE INVENTION

The application relates to a method and apparatus providing for the protection of the sound emitted by an audio device from physical interference during use of the audio device, particularly for audio devices which also function as at least one of the following: mobile phone, telephone, smart phone, or multimedia player.

### Prior Art

Audio devices and mobile devices with audio capabilities have steadily become smaller and smaller in size. Many such devices are small enough to be handheld. Furthermore, some of these devices employ touch-screens which require the use of one or more fingers or styluses to touch the screen during operation. Additionally, many of these devices feature their speakers on the body of the device. This placement coupled with the handheld nature of these devices sometimes leads to the physical interference of the sound waves emitted by the audio device due to the placement of the user's fingers or hands during regular use. The interference this causes can distort or muffle the sounds the audio device emits such that the user's audio experience is less than ideal.

There exists a need for a method or apparatus that guards the sound emitted by these audio devices or mobile devices with audio capabilities, including telephones, mobile phones, smart phones, multimedia devices and other audio devices, while allowing for regular use of the audio device or mobile device.

### OBJECTS AND ADVANTAGES

Accordingly, several objects and advantages of this invention are:
(a) To protect the integrity, clarity, intensity, or quality of the sound emitted by an audio device, those which also function as at least one of the following: mobile phone, telephone, smart phone, or multi-media player.;
(b) To redirect the sound emitted by the audio device toward the user;
(c) To further protect the speakers of the audio device from dust, dirt, or otherwise unwanted materials;
(d) To provide aesthetic flair to the audio device.

Further objects and advantages of this invention will become apparent from a consideration of the drawings and ensuing description.

### SUMMARY OF THE INVENTION

The following summary is provided to facilitate an understanding of some of the innovative features unique to the embodiments and is not intended to be a full description. A full appreciation of the various aspects of the embodiments can be gained by taking the entire specification, claims, drawings, and abstract as a whole.

In accordance with the present invention a method and apparatus for providing for the protection of the sound emitted by an audio device from physical interference during use of the audio device, particularly for audio devices which also function as at least one of the following: mobile phone, telephone, smart phone, or multimedia player.

### BRIEF DESCRIPTION OF THE DRAWINGS

FIG. 1 is a perspective view of the prior art during normal use.

FIG. 2 is a perspective view of the present invention during normal use.

FIG. 3 is a perspective view of a certain embodiment of the present invention.

FIG. 4 is a perspective view of a certain embodiment of the present invention.

FIG. 5 is a perspective view of a certain embodiment of the present invention.

FIG. 6 is a perspective view of a certain embodiment of the present invention.

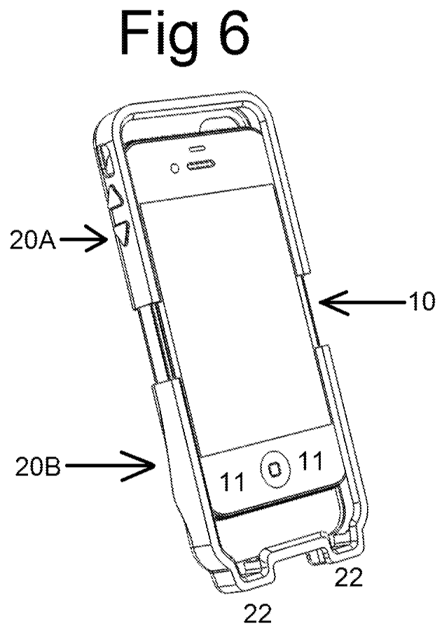

FIG. 7 is a close up view of the bottom of the phone housing from FIG. 3.

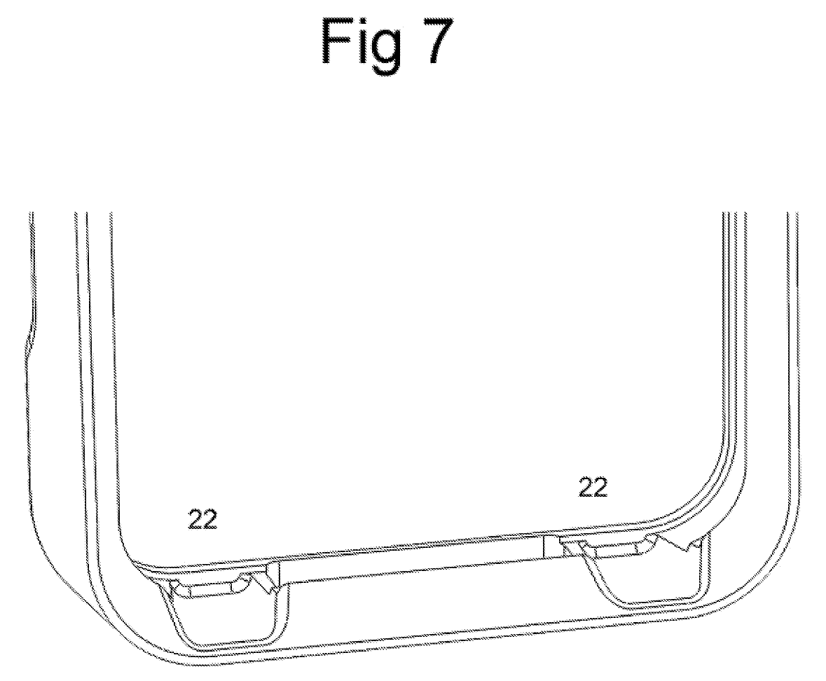

FIG. 8 is a close up view of the bottom of the phone housing from FIG. 4.

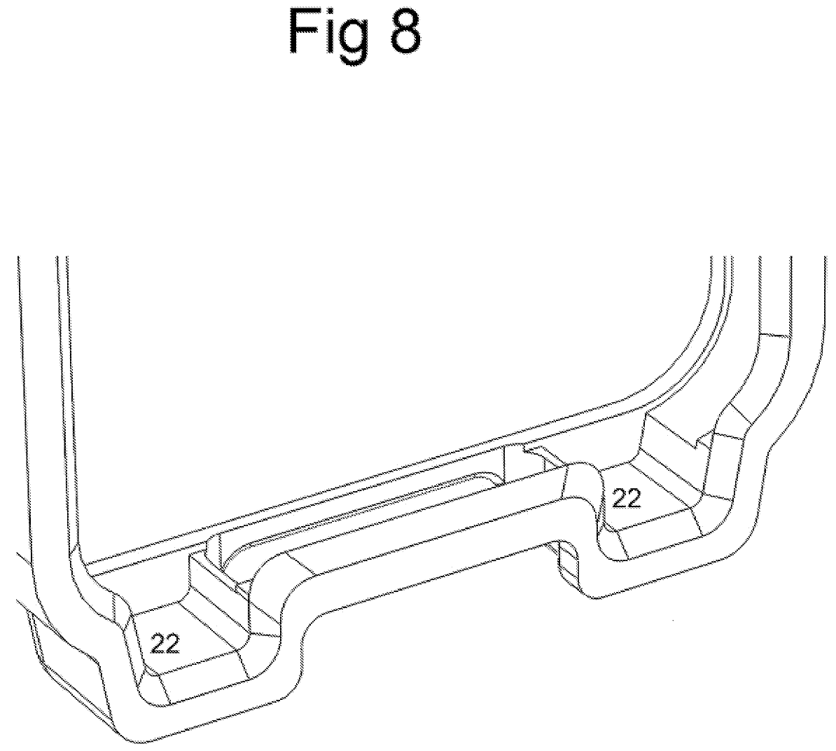

So that the manner in which the above recited features, advantages and objects of the present invention are attained and can be understood in detail, a more particular description of the invention, briefly summarized above, may be had by reference to the preferred embodiment thereof which is illustrated in the appended drawings, which drawings are incorporated as a part hereof.

It is to be noted however, that the appended drawings illustrate only a typical embodiment of this invention and are therefore not to be considered limiting of its scope, for the invention may admit to other equally effective embodiments.

### DETAILED DESCRIPTION

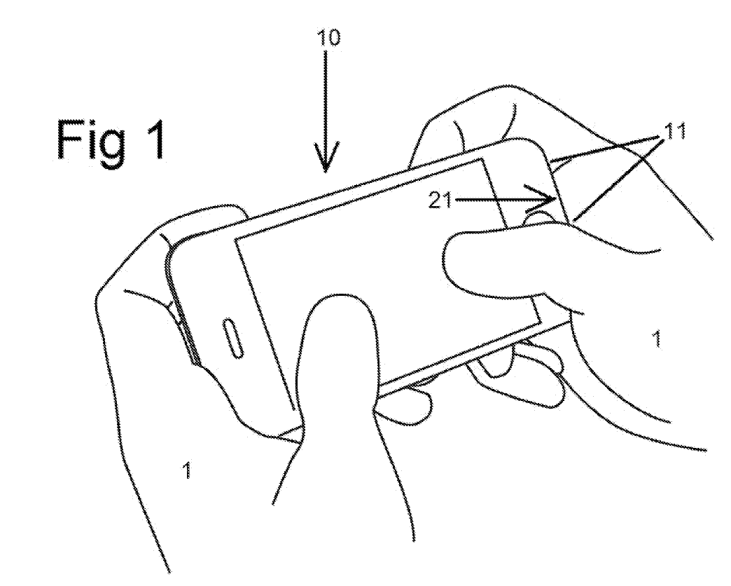

### FIGS. 1, 2, 5

With reference now to the drawings, the preferred embodiment of the speaker guard for audio devices according to the present invention is herein described. As can be seen in FIG. 1, according to the prior art phone or other audio device 10 is held in user's hands 1 such that user's hands 1 cover speakers of audio device 11.

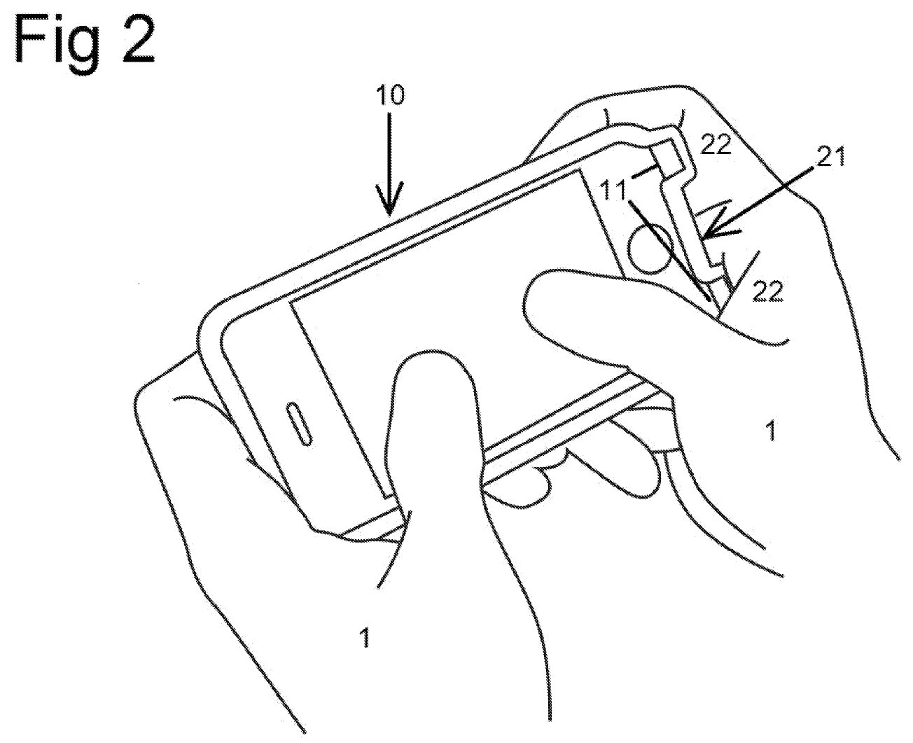

According to certain embodiments, as shown in FIG. 2 in the present invention, phone or other audio device 10 is held in user's hands 1 such that user's hands 1 cover speaker guards 22.

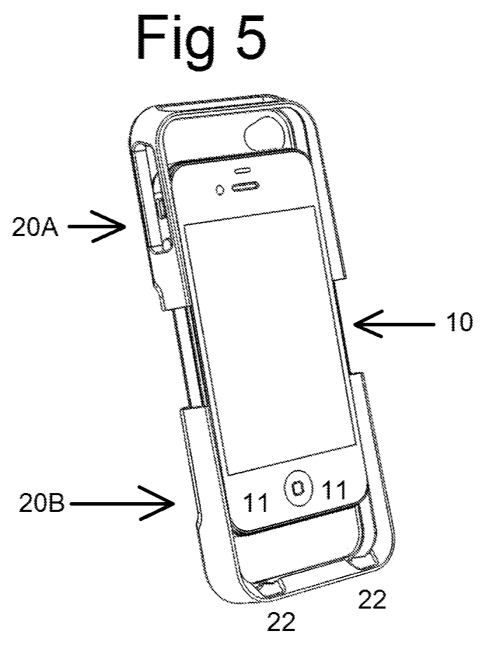

According to certain embodiments, as shown in FIG. 5 in the present invention, top portion of phone housing 20A corresponds to bottom portion of phone housing 20B. Speaker guards 22 cover speakers 11 when phone or audio device 10 is placed in phone housing portions 20A and 20B.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

The invention may be embodied in other forms without departing from the spirit or essential characteristics thereof. The present embodiments are therefore to be considered as illustrative and not restrictive, the scope of the invention being indicated by the appended claims rather than by the foregoing description, and all changes that come within the meaning and range of equivalency of the claims are therefore intended to be embraced therein.

### Operation

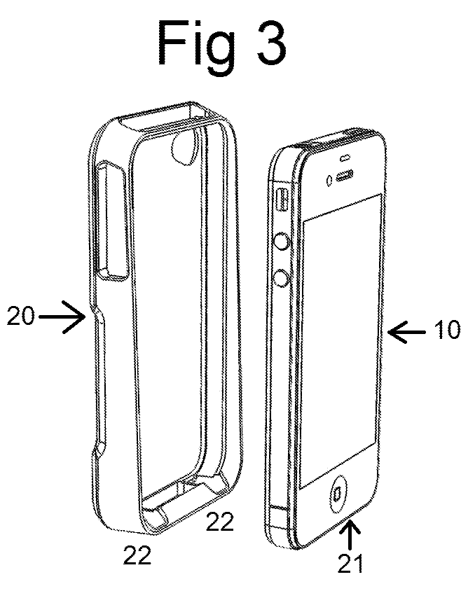

### FIGS. 1-5

According to certain embodiments, as shown in FIG. 1, according to the prior art, when phone or audio device 10 is being held by user, user's hand 1 covers portion of audio device housing speakers 21 such that user's hand 1 interferes with the optimum quality of sound emitted from speakers 11.

According to certain embodiments, as shown in FIG. 2, according to the present invention, when phone or audio device 10 is being held by user, user's hand 1 covers potion of audio device housing speakers 21. Speaker guards 22 protect speakers 11 from unintentional direct physical interference by user's hands 1.

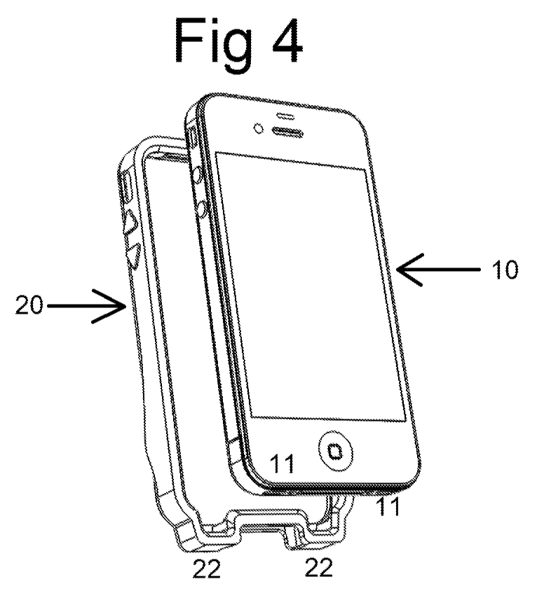

According to certain embodiments, as shown in FIG. 4, according to the present invention, phone or audio device 10 is inserted into phone housing 20 such that speaker guards 22 protect speakers 11 from unintentional direct physical interference.

According to certain embodiments, as shown in FIG. 5, according to the present invention, top portion of phone housing 20A and bottom portion of phone housing 20B cover phone or audio device 10 such that speaker guards 22 protect speakers 11 from unintentional direct physical interference.

### CONCLUSION, RAMIFICATIONS, AND SCOPE

Thus, the reader will see that the method and apparatus will provide for the protection of the sound emitted by an audio device from physical interference during use of the audio device. While the above description contains many specifications, these should not be construed as limitations of the scope of the invention, but rather as an exemplification of a preferred embodiment of the invention. Many other variations and embodiments are possible.

Accordingly, the scope of the invention should be determined not by the embodiment illustrated, but by the appended claims and their legal equivalents.

I claim:

1. A housing for an audio device comprising;
any number of holes corresponding to the position of any number of speakers on the audio device;
a means to prevent said hole or holes from being physically covered or obstructed;

2. The means from claim 1 wherein said means further comprises a walled portion of said housing;

3. The walled portion from claim 2 whereby the walls of said walled portion prevent unwanted materials or objects from covering or obstructing the hole or holes.

4. The walled portion from claim 2 whereby the walls of said walled portion reflect the sound emitted by said audio device;

5. The walled portion from claim 4 wherein the reflected sound is reflected toward the user.

6. The walled portion from claim 4 whereby the overall audio experience of the user is an improvement upon the audio device without said housing.

7. The housing from claim 1 wherein said audio device may also function as at least one of the following: mobile phone, telephone, smart phone, or multimedia player.

8. An audio device comprising;
A mechanism for transmitting sound;
A means to prevent said mechanism from being physically covered or obstructed;

9. The means from claim 7 further comprising a walled portion of said audio device;

10. The walled portion from claim 8 whereby the walls of said walled portion prevent unwanted materials or objects from covering or obstructing the mechanism for transmitting sound.

11. The walled portion from claim 8 whereby the walls of said walled portion reflect the sound emitted by said audio device;

12. The walled portion from claim 10 wherein the reflected sound is reflected toward the user.

13. The walled portion from claim 4 whereby the overall audio experience of the user is an improvement upon the audio device without said housing.

14. The audio device from claim 8 wherein said audio device also functions as at least one of the following: mobile phone, telephone, smart phone, or multimedia player.
